(19) United States
(12) Patent Application Publication
(10) Pub. No.: US 2025/0139882 A1
(43) Pub. Date: May 1, 2025

(54) CYLINDRICAL PARTITIONING FOR THREE-DIMENSIONAL (3D) PERCEPTION OPERATIONS

(71) Applicant: QUALCOMM Incorporated, San Diego, CA (US)

(72) Inventors: Behnaz Rezaei, San Diego, CA (US); Varun Ravi Kumar, San Diego, CA (US); Senthil Kumar Yogamani, Headford (IE)

(21) Appl. No.: 18/498,995

(22) Filed: Oct. 31, 2023

(51) Int. Cl. G06T 17/00; G06T 7/12; G06T 7/62; G06V 10/44; G06V 20/56

(52) U.S. Cl. CPC G06T 17/00; G06T 7/12; G06T 7/62; G06V 10/44; G06V 20/588; G06T 2207/30256; G06V 2201/07

(57) ABSTRACT

In some aspects of the disclosure, an apparatus includes a processing system that includes one or more processors and one or more memories coupled to the one or more processors. The processing system is configured to receive sensor data associated with a scene and to generate a cylindrical representation associated with the scene. The processing system is further configured to modify the cylindrical representation based on detecting a feature of the cylindrical representation being included in a first region of the cylindrical representation. Modifying the cylindrical representation includes relocating the feature from the first region to a second region that is different than the first region. The processing system is further configured to perform, based on the modified cylindrical representation, one or more three-dimensional (3D) perception operations associated with the scene.

### TECHNICAL FIELD

Aspects of the present disclosure relate generally to three-dimensional (3D) perception operations.

### INTRODUCTION

Electronic devices may use sensors to generate a representation of a scene and may use the representation to perform operations, such as navigation. For example, a vehicle can use sensors to generate a point cloud that represents a scene proximate to the vehicle. The scene may include a roadway, one or more other vehicles, one or more pedestrians, and other objects. The vehicle may use the point cloud to navigate around such objects.

In generating a point cloud, some devices may map data points associated with detected objects into a grid of cells (such as voxels or pillars) using a cartesian coordinate system. If the cells have a common scale, then data points may be unevenly distributed inside each cell of the grid, which can result in inefficient performance. For example, many cells may be empty or may include relatively few data points (which may be referred to as the long-tailed distribution of density).

Some devices may use another type of coordinate system other than a cartesian coordinate system. For example, a device may use a polar or cylindrical coordinate system for data representation. However, use of such a non-cartesian coordinate system may result in an inaccurate representation of some detected objects. For example, an elongated object, such as a guard rail, barrier, or trailer, may appear curved or distorted in a non-cartesian coordinate system in some circumstances. To further illustrate, in some circumstances, an elongated object may appear discontinuous or curved when represented using a cylindrical coordinate system, which may reduce accuracy of 3D perception operations.

### BRIEF SUMMARY OF SOME EXAMPLES

In some aspects of the disclosure, an apparatus includes a processing system that includes one or more processors and one or more memories coupled to the one or more processors. The processing system is configured to receive sensor data associated with a scene and to generate a cylindrical representation associated with the scene. The processing system is further configured to modify the cylindrical representation based on detecting a feature of the cylindrical representation being included in a first region of the cylindrical representation. Modifying the cylindrical representation includes relocating the feature from the first region to a second region that is different than the first region. The processing system is further configured to perform, based on the modified cylindrical representation, one or more three-dimensional (3D) perception operations associated with the scene.

In some other aspects, a method includes receiving sensor data associated with a scene and generating a cylindrical representation associated with the scene. The method further includes modifying the cylindrical representation based on detecting a feature of the cylindrical representation being included in a first region of the cylindrical representation. Modifying the cylindrical representation includes relocating the feature from the first region to a second region that is different than the first region. The method further includes performing one or more three-dimensional (3D) perception operations associated with the scene based on the modified cylindrical representation.

In some other aspects, a non-transitory computer-readable medium stores instructions executable by one or more processors to initiate, perform, or control operations. The operations include receiving sensor data associated with a scene and generating a cylindrical representation associated with the scene. The operations further include modifying the cylindrical representation based on detecting a feature of the cylindrical representation being included in a first region of the cylindrical representation. Modifying the cylindrical representation includes relocating the feature from the first region to a second region that is different than the first region. The operations further include performing one or more three-dimensional (3D) perception operations associated with the scene based on the modified cylindrical representation.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a diagram illustrating an example of a device for cylindrical partitioning in accordance with some aspects of the disclosure

FIG. 2 is a diagram illustrating an example of cylindrical partitioning in accordance with some aspects of the disclosure.

FIG. 3 is a diagram illustrating examples of operations that may be performed in connection with cylindrical partitioning in accordance with some aspects of the disclosure.

FIG. 4 is a flow chart illustrating an example of a method that may be performed in connection with cylindrical partitioning in accordance with some aspects of the disclosure.

Like reference numbers and designations in the various drawings indicate like elements.

### DETAILED DESCRIPTION

In some aspects of the disclosure, a device may modify a cylindrical representation of a scene by relocating one or more data points from one region of the cylindrical representation to another region of the cylindrical representation. For example, the cylindrical representation may be associated with an angular coordinate (θ), and the one or more data points may be relocated from with a region associated with values of the angular coordinate less than zero (θ<0) to a region associated with values of the angular coordinate greater than or equal to zero (θ≥0). The region associated with values of the angular coordinate less than zero (θ<0) may be referred to as a “bottom region” of the cylindrical representation, and the region associated with values of the angular coordinate greater than or equal to zero (θ≥0) may be referred to as a “top region” of the cylindrical representation.

One or more features described herein may improve performance of a device (such as a vehicle) that performs three-dimensional (3D) perception operations. For example, by relocating one or more data points from the bottom region of a cylindrical representation to the top region of the cylindrical representation, a feature appearing in multiple fields of view of different sensors or cameras may appear continuous (or linear) instead of discontinuous (or curved). As a result, a device may achieve certain benefits of cylindrical representations (such as by reducing or avoiding the problem of long-tailed distribution of density) while reducing or avoiding inaccurate representation of some detected objects (such as by reducing or avoiding undesirable curvature or discontinuity of an elongated object, such as a guard rail, barrier, or trailer).

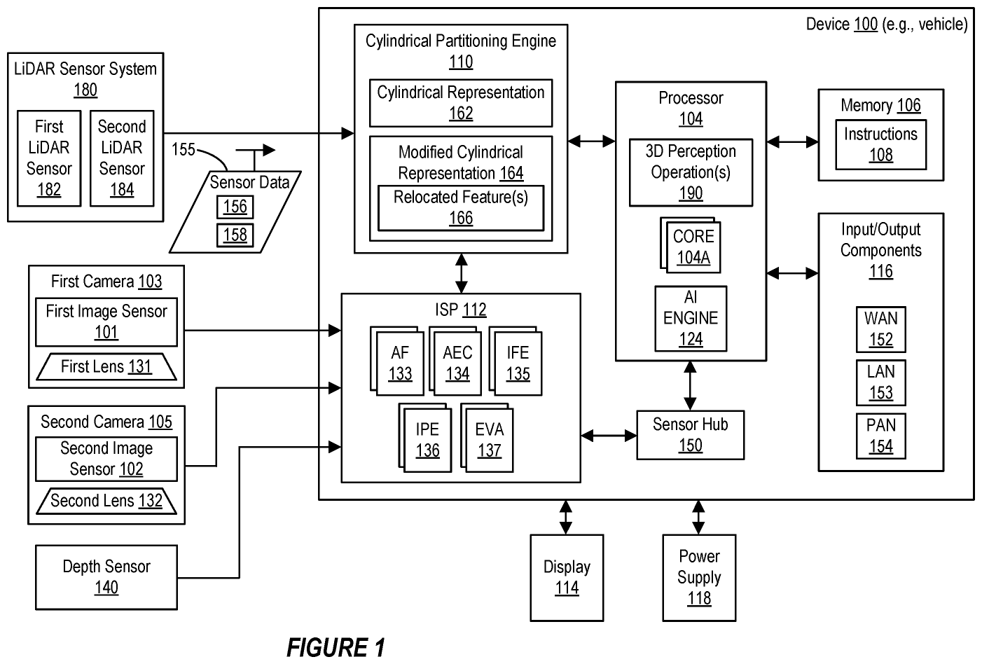

FIG. 1 is a diagram illustrating an example of a device 100 for cylindrical partitioning in accordance with some aspects of the disclosure. In some examples, the device 100 may include or may be coupled to one or more sensor systems, such as a light detection and ranging (LiDAR) sensor system 180. The LiDAR sensor system 180 may include one or more sensors, such as one or more of a first LiDAR sensor 182 or a second LiDAR sensor 184.

Alternatively, or in addition, the device 100 may include or may be coupled to one or more other sensor systems. For example, the device 100 may include or may be coupled to a sensor system that includes one or more of a first camera 103 or a second camera 105. The first camera 103 may include a first image sensor 101 and a first lens 131, and the second camera 105 may include a second image sensor 102 and a second lens 132.

Alternatively, or in addition, the device 100 may include or may be coupled to a depth sensor 140. In some examples, the depth sensor 140 may include one or more of an indirect time of flight (iToF) sensor, a direct time of flight (dToF) sensor, a LiDAR sensor, a millimeter wave (mmWave) sensor, a radio detection and ranging (radar) sensor, or a hybrid depth sensor, such as a structured light sensor, as illustrative examples.

The device 100 may include, or otherwise be coupled to, an image signal processor (e.g., ISP 112) for processing image frames from one or more image sensors, such as the first image sensor 101, the second image sensor 102, and the depth sensor 140. In some implementations, the device 100 also includes or is coupled to a processor 104 and a memory 106 storing instructions 108. The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device 100 may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and to the second image sensor 102. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first lens 131 and the second lens 132 may be controlled by an associated an autofocus (AF) algorithm (e.g., AF 133) executing in the ISP 112, which may adjust the first lens 131 and the second lens 132 to focus on a particular focal plane located at a certain scene depth. The AF 133 may be assisted by depth data received from the depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. Output from the depth sensor 140 may be processed in a similar manner to that of the first camera 103 and the second camera 105. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform one or more operations described herein. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein. For example, execution of the instructions can instruct the ISP 112 to begin or end capturing an image frame or a sequence of image frames, in which the capture includes correction as described in embodiments herein. In some embodiments, the processor 104 may include one or more processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

In some aspects of the disclosure, the device 100 may include or may execute a cylindrical partitioning engine 110 to initiate, perform, or control one or more operations described herein. In some examples, the processor 104 may include the cylindrical partitioning engine 110. In some other examples, the cylindrical partitioning engine 110 may be included in another processor or component of the device 100. In some implementations, operations described with reference to the cylindrical partitioning engine 110 may be performed by one processor (e.g., the processor 104) or may be performed collectively by multiple processors, such as by the processor 104 and one or more other processors.

The cylindrical partitioning engine 110 may receive sensor data 155 representing a scene (e.g., an area traveled by a vehicle, such as a roadway traveled by a motor vehicle). In some examples, the sensor data 155 may include LidAR sensor data received from the LiDAR sensor system 180. Alternatively, or in addition, in some examples, the sensor data 155 may include image sensor data received from one or more of the first camera 103 or the second camera 105, depth sensor data received from the depth sensor 140, or a combination hereof. Further, depending on the implementation, the device 100 may generate the sensor data 155 using a single sensor or using multiple sensors. In some examples, the sensor data 155 may include a point cloud, such as a LiDAR point cloud.

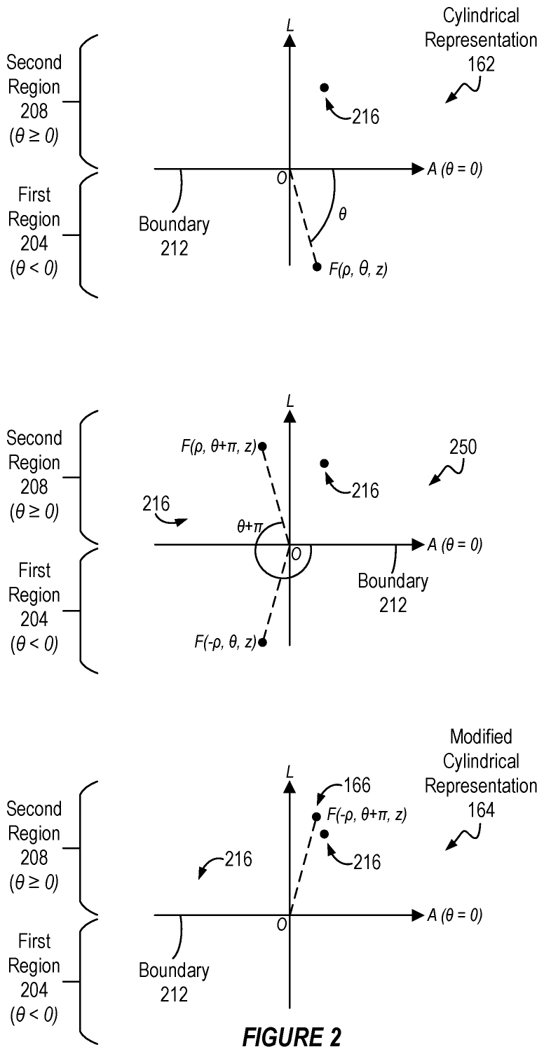

The cylindrical partitioning engine 110 may generate a cylindrical representation 162 associated with the sensor data 155. To illustrate, features of a scene indicated by the sensor data 155 may be mapped from one coordinate system or representation (such as a cartesian representation) to a cylindrical coordinate system to generate the cylindrical representation 162. Further, the cylindrical partitioning engine 110 may modify the cylindrical representation 162 to generate a modified cylindrical representation 164 including one or more relocated features 166. In some examples, the one or more relocated features 166 may include one or more detected objects associated with a field of travel of a vehicle, such as another vehicle, a pedestrian, or a road surface, as illustrative examples. Certain examples that may be associated with the modified cylindrical representation 164 are described further with reference to FIG. 2.

In some implementations, the device 100 may perform one or more three-dimensional (3D) perception operations 190 based on the modified cylindrical representation 164. To illustrate, the one or more 3D perception operations 190 may include one or more of object detection, instance segmentation, lane detection, or road detection, as illustrative examples. In some implementations, the device 100 may perform the one or more 3D perception operations 190 using a convolutional neural network (CNN) engine, which may be included in or which may correspond to the AI engine 124. Alternatively, or in addition, in some other implementations, the device 100 may perform one or more other operations based on the modified cylindrical representation 164.

In some illustrative examples, the device 100 may correspond to a vehicle, such as a motor vehicle (e.g., a car, truck, bus, motorcycle, or scooter), a railed vehicle, a watercraft, an amphibious vehicle, or a spacecraft. Examples of vehicles include autonomous vehicles (e.g., drones), non-autonomous vehicles, and partially autonomous vehicles. Other examples are also within the scope of the disclosure. For example, in some implementations, the device 100 may correspond to a robot or another type of device.

In some examples, the device 100 may include or may be in communication with a sensor system, such as the LiDAR sensor system 180, a camera sensor system that includes one or more of the first camera 103 or the second camera 105, a depth sensor system that includes the depth sensor 140, or a combination thereof. The device 100 may use the sensor system during navigation or other operations. For example, the device 100 may use the LiDAR sensor system 180 to transmit a signal (e.g., a LiDAR signal) and may detect reflections of the signal. The LiDAR sensor system 180 (or the device 100) may generate the sensor data 155 based on the reflections of the signal. Other examples are also within the scope of the disclosure.

In some examples, the sensor data 155 may include a representation of one or more objects, such as objects within a field of travel of a vehicle. In some examples, the sensor data 155 may represent a field of view of 180 degrees or more. For example, the LiDAR sensor system 180 may include multiple sensors having different orientations, such as a first sensor (e.g., a front-facing sensor of the device 100) and a second sensor (e.g., a rear-facing sensor or a side-facing sensor of the device 100). In some examples, the first sensor may correspond to the first LiDAR sensor 182, and the second sensor may correspond to the second LiDAR sensor 184. In some other examples, the first sensor may correspond to the first image sensor 101, and the second sensor may correspond to the second image sensor 102. In an example, the sensor data 155 may include first sensor data 156 associated with the first sensor and may further include second sensor data 158 associated with the second sensor. Further, the scene represented by the sensor data 155 may include an object represented by the both the first sensor data 156 and the second sensor data 158. For example, the object may include at least a first portion within a first field of view of the first sensor and at least a second portion within a second field of view of the second sensor. To illustrate, the object may correspond to a guard rail, a barrier, a trailer, or another type of elongated object. In such examples, the object may be discontinuous or curved within the cylindrical representation 162 (e.g., where the first portion is represented discontinuously with respect to the second portion). In some aspects, generating the modified cylindrical representation 164 may include moving a feature associated with the second portion to be nearer to, or continuous with respect to, a feature associated with the first portion. In some examples, relocating the feature may increase one or more of continuity or linearity associated with the object in the modified cylindrical representation 164 as compared to the cylindrical representation 162, as described further with reference to FIG. 2.

FIG. 2 is a diagram illustrating an example of cylindrical partitioning in accordance with some aspects of the disclosure. One or more operations described with reference to FIG. 2 may be performed by the device 100, such as by executing the cylindrical partitioning engine 110.

In FIG. 2, the cylindrical representation 162 and the modified cylindrical representation 164 may each be associated with an origin O, a polar axis A, and a longitudinal axis L. In FIG. 2, features may be represented using a radial distance, an angular coordinate, and a height. For example, in the cylindrical representation 162, a feature F may be associated with a radial distance ρ, an angular coordinate θ, and a height z.

FIG. 2 also illustrates that the cylindrical representation 162 and the modified cylindrical representation 164 may each include a first region 204 and a second region 208. In an example, the first region 204 may be associated with values of the angular coordinate of less than zero (θ<0), and the second region 208 may be associated with values of the angular coordinate of greater than or equal to zero (θ≥0). To illustrate, the feature F may be associated with a negative value of the angular coordinate (θ<0) and may be associated with the first region 204. Another feature 216 may be associated with a positive value of the angular coordinate (θ≥0) and may be associated with the second region 208.

In some aspects of the disclosure, one or more features associated with the first region 204 (such as a feature near a boundary 212 between the first region and the second region 208) may be relocated to be near (e.g., next to) one or more features in the second region 208. For example, the feature F may be relocated from the first region 204 to the second region 208 in the modified cylindrical representation 164. Further, as illustrated in FIG. 2, one or more features associated with the second region 208 in the cylindrical representation 162 may remain in the second region 208 in the modified cylindrical representation 164 without relocation. For example, the feature 216 may remain in a common position in the cylindrical representation 162 and the modified cylindrical representation 164. In addition, in some examples, the modified cylindrical representation 164 may exclude any features in the first region 204 (e.g., the modified cylindrical representation 164 may be “empty” in the first region 204).

In some examples, one or more features associated with the first region 204 (such as the feature F) may be relocated to the second region 208 based on a radial adjustment value, based on an angular shift value, or both. For illustration, examples separately applying the radial adjustment value and the angular shift value are shown in FIG. 2 at 250. After applying both the radial adjustment value and the angular shift value, the feature F may have the location shown in the modified cylindrical representation 164. In the modified cylindrical representation 164, the feature F may correspond to or may be included in the one or more relocated features 166.

To further illustrate, the feature F may be associated with a radial distance ρ from the origin O of the cylindrical representation 162 in the cylindrical representation 162, and relocating the feature F from the first region 204 to the second region 208 may include modifying the radial distance ρ based on the radial adjustment value. In some implementations, the radial adjustment value is negative one. In some implementations, relocating the feature F from the first region 204 to the second region 208 may include multiplying the radial distance ρ based on the radial adjustment value. In such examples, the feature F may be associated with a radial distance of −ρ in the modified cylindrical representation 164.

The example of FIG. 2 also illustrates that the feature F may be associated with an angular distance θ from the polar axis A in the cylindrical representation 162. Relocating the feature F from the first region 204 to the second region 208 may include modifying the angular distance θ based on the angular shift value. In some implementations, the angular shift value may be pi radians. In some implementations, relocating the feature F from the first region 204 to the second region 208 may include adding the angular shift value to the angular distance θ. In such examples, the feature F may be associated with an angular distance of θ+π in the modified cylindrical representation 164.

To further illustrate, the boundary 212 between the first region and the second region 208 may correspond to a particular value of the angular coordinate. In FIG. 2, the particular value may correspond to zero (θ=0). Further, relocating the feature F from the first region 204 to the second region 208 may include or may be referred to as reflecting (or mirroring) the feature F across the boundary 212 (and across the a polar axis A). Other examples are also within the scope of the disclosure. For example, in some implementations, the boundary 212 may correspond to a boundary between a first field of view of the first LiDAR sensor 182 (e.g., a front-facing sensor of a vehicle) and a second field of view of the second LiDAR sensor 184 (e.g., a rear-facing sensor or a side-facing sensor of the vehicle).

In some examples, the one or more relocated features 166 and the feature 216 may correspond to a common object. For example, the common object may correspond to an elongated object, such as a guard rail, a barrier, or a trailer, and may have a first portion within a first field of view of the first LiDAR sensor 182 and a second portion within a second field of view of the second LiDAR sensor 184. In some examples, relocating the feature F from the first region 204 to the second region 208 in the modified cylindrical representation 164 may enable representation of the feature as F as being nearer to, or continuous with, the feature 216 as compared to the cylindrical representation 162. As a result, the modified cylindrical representation 164 may represent the object more accurately as compared to the cylindrical representation 162, such as if the object appears curved or discontinuous based on the cylindrical representation 162 while appearing more straight or continuous based on the modified cylindrical representation 164.

Although some examples may be described with reference to a point (such as a point associated with a single polar coordinate value, a single longitudinal coordinate value, and a single angular coordinate value), other examples are also within the scope of the disclosure. For example, a feature may be associated with a range of polar coordinate values, a range of longitudinal coordinate values, a range of angular coordinate values, or a combination thereof. In some circumstances, a particular feature may include a first portion associated with one or more angular coordinate values in the first region 204 and may include a second portion associated with one or more angular coordinate values in the second region 208. In some implementations, only the first portion may be shifted. In some other implementations, both the first portion and the second portion may be shifted (e.g., to maintain continuity or visual accuracy associated with the particular feature).

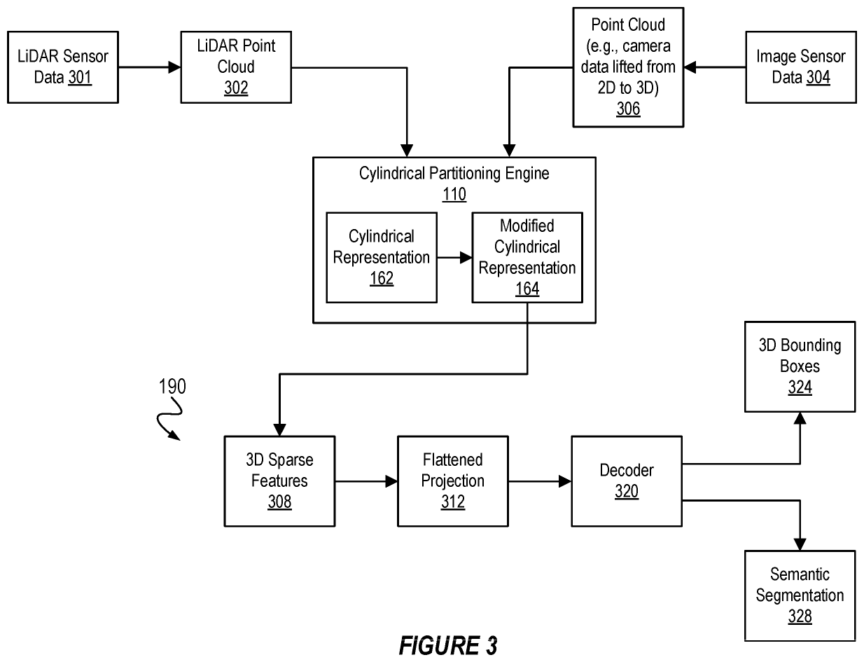

FIG. 3 is a diagram illustrating examples of operations that may be performed in connection with cylindrical partitioning in accordance with some aspects of the disclosure. One or more operations described with reference to FIG. 3 may be performed by the device 100, such as using the processor 104, one or more other processors, or a combination thereof.

In FIG. 3, the operations may include one or more of receiving LiDAR sensor data 301 (e.g., from the LiDAR sensor system 180) or receiving image sensor data 304 (e.g., from an image sensor system that may include one or more of the first camera 103 or the second camera 105). In some examples, one or more of the LiDAR sensor data 301 or the image sensor data 304 may be included in the sensor data 155 of FIG. 1. The operations of FIG. 3 may further include generating a LiDAR point cloud 302 based on the LiDAR sensor data 301 and generating a point cloud 306 based on the image sensor data 304. For example, the processor 104, the cylindrical partitioning engine 110, or the ISP 112 may convert (or “lift”) the image sensor data 304 from a two-dimensional (2D) space to a three-dimensional (3D) space to generate the point cloud 306.

The cylindrical partitioning engine 110 may receive one or more of the LiDAR point cloud 302 or the point cloud 306. The cylindrical partitioning engine 110 may generate the cylindrical representation 162 based on one or more of the LiDAR point cloud 302 or the point cloud 306. The cylindrical partitioning engine 110 may modify the cylindrical representation 162 to generate the modified cylindrical representation 164, such as using one or more techniques described with reference to FIG. 2, as an illustrative example.

In some implementations, the operations described with reference to FIG. 3 may include the one or more 3D perception operations 190 of FIG. 1. To illustrate, the one or more 3D perception operations 190 may include determining 3D sparse features 308 (e.g., by applying 3D sparse convolutional layers) and determining a flattened projection 312 based on the 3D sparse features 308, such as by projecting the 3D sparse features 308 to a 2D birds-eye view (BEV) to determine BEV features associated with the 3D sparse features 308.

The one or more 3D perception operations 190 may include inputting the flattened projection 312 to a decoder 320, such as a LiDAR/perception decoder or another decoder. The decoder 320 may perform decoding of the flattened projection 312 to generate decoded feature data, such as by performing 2D convolutional feature extraction based on the BEV features.

The one or more 3D perception operations 190 may further include determining 3D bounding boxes 324 based on the decoded feature data, such as by performing 3D bounding box regression and classification. The one or more 3D perception operations 190 may also include performing semantic segmentation 328 based on the decoded feature data.

In some examples, the one or more 3D perception operations 190 may further include one or more navigation operations. For example, one or more of the 3D bounding boxes 324 or the semantic segmentation 328 may be used to detect an object or navigation path of a vehicle (such as the device 100). One or more control signals may be provided (e.g., by the processor 104) to one or more systems or sub-systems of the vehicle, such as one or more of a steering control signal to a steering system of the vehicle, an acceleration control signal to a motor of the vehicle, or a deceleration control signal to a brake system of the vehicle. Alternatively, or in addition, an alert (such as graphic alert, an auditory alert, or a combination of both) may be initiated (e.g., by the processor 104) for a driver of the vehicle.

FIG. 3 illustrates an example in which a “fused” technique may use both LiDAR and camera data. Those of skill in the art will recognize that other examples are within the scope of the disclosure. For example, other implementations may use LiDAR data only, camera data only, or one or more other types of data.

To further illustrate some aspects of the disclosure, illustrative pseudocode is provided below as Example 1. In some examples, the cylindrical partitioning engine 110 of FIG. 1 may operate in accordance with Example 1.

### Example 1

### Input:

input_xyz: pointcloudcoordinates,
max_bound: upperboundforthedetectionrange,
min_bound: lowerboundfordetectionrang
grid_size: resolution of the data after partitioning
   Convert the cartesian to the cylindrical coordinates:
   input_cyl=cylindrical_conversion(input_xyz)
   Crop the values outside the given range
   Compute the intervals for partitioning given the range and grid_size
   Change the cylinder representation to custom cylindrical representation:
      Find the lower half and upper half indices of the polar region:
      lower_half_ind=input_cyl[:, 1]<0
      upper_half_ind=input_cyl[:, 1]>=0
      Negate the range (rho) value of the lower half indices and shift the upper half azimuth by π:
      input_cyl[lower_half_ind, 0]=−input_cyl[lower_half_ind, 0]
      input_cyl[lower_half_ind, 1]=np.pi+input_cyl[lower_half_ind, 1]
      input_cyl[uper_half_ind, 1]=np.pi-input_cyl[uper_half_ind, 1]
      min_bound[0]=−max_bound[0]
      min_phi, max_phi=0.0, np.pi
      min_bound[1]=min(min_phi, max_phi)
      Calculate the grid indices with given representation above:
      grid_ind=(np.floor((input_cyl−min_bound)/intervals)).astype(np.int)
      cell_centers_cyl=((grid_ind.astype(np.float32)+0.5)*intervals+min_bound).astype(np.float32)

### Output:

grid_ind,
cell_centers_cyl

In Example 1, a set of Cartesian coordinates (input_xyz) may be converted to cylindrical coordinates (input_cyl) using a cylindrical_conversion ( ) function. In some examples, input_xyz may correspond to the LiDAR point cloud 302 or the point cloud 306, and input_cyl may correspond to the cylindrical representation 162. One or more values outside of a particular range (min_bound to max_bound) within input_cyl may be cropped or removed, and one or more other values within input_cyl may be partitioned into a grid having a particular resolution (grid_size). In some aspects of the disclosure, a customized cylindrical representation may be generated by negating a range value (p) of the lower half indices and shifting the upper half azimuth by π. For example, for lower half indices (where θ<0): ρ′=ρ, and θ′=π+θ. For upper half indices (θ≥0): θ′=π−θ.

Further, in Example 1, grid indices (grid_ind) may be determined for each point based on Equation 1:

$$grid\_ind = floor ( ( input\_cyl - min\_bound ) / intervals ) . \qquad ( Equation 1 )$$

In Equation 1, intervals may indicate a size of each grid cell, and min_bound may indicate a lower bound of the range. The resulting grid indices may be used to calculate the centers of each grid cell (cell_centers_cyl) in accordance with Equation 2:

$$cell\_centers \_cyl = ( grid\_ind + 0.5 ) * intervals + min\_bound . \qquad ( Equation 2 )$$

Accordingly, the pseudocode illustrated in Example 1 may facilitate adaptive cylindrical partitioning of a set of cylindrical coordinates into a grid and calculation of grid indices and cell centers for each point within a particular range. Alternatively, or in addition, in some aspects of the disclosure, a bounding box may be used in connection with the cylindrical partitioning engine 110. For example, a detected object associated with one or more of the features 166, 216 may be associated with the bounding box. Instead of using length and width dimensions of the bounding box (e.g., as may be used in connection with cartesian coordinates), locations of corners of the bounding box along a diameter of the bounding box may be determined. In some aspects, length and width dimensions of the bounding box may be determined using the locations of the corners. In some implementations, when using cylindrical coordinates, determining the locations of the corners of the bounding box may be more efficient as compared to determining the length and width dimensions of the bounding box. As a result, operation may be simplified by first determining the locations of the corners of the bounding box.

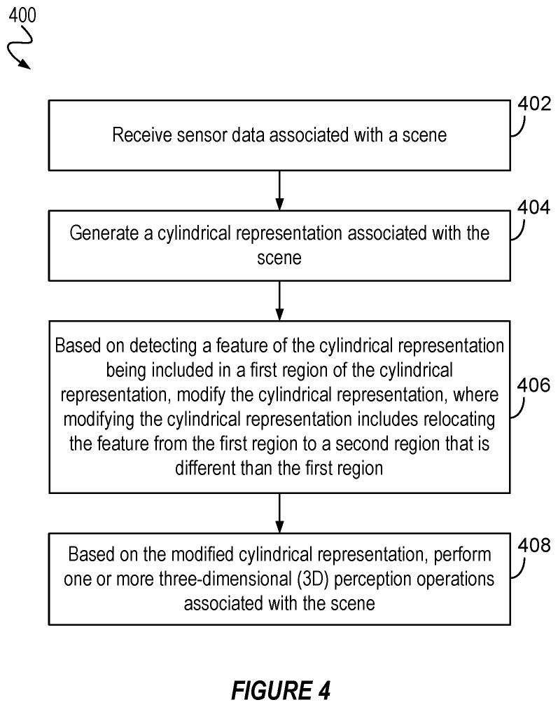

FIG. 4 is a flow chart illustrating an example of a method 400 that may be performed in connection with cylindrical partitioning in accordance with some aspects of the disclosure. In some aspects, the method 400 may be performed by the device 100 of FIG. 1, such as by the processor 104, one or more other processors, or a combination thereof. In some examples, the processor 104 may execute the cylindrical partitioning engine 110 to initiate, perform, or control one or more operations described with reference to FIG. 4.

The method 400 includes receiving sensor data associated with a scene, at 402. To illustrate, the sensor data may include any of the sensor data 155, the LiDAR sensor data 301, the image sensor data 304, the LiDAR point cloud 302, or the point cloud 306.

The method 400 further includes generating a cylindrical representation associated with the scene, at 404. For example, the cylindrical representation may correspond to the cylindrical representation 162.

The method 400 further includes, based on detecting a feature of the cylindrical representation being included in a first region of the cylindrical representation, modifying the cylindrical representation, at 406. Modifying the cylindrical representation includes relocating the feature from the first region to a second region that is different than the first region. For example, the one or more features may be relocated from the first region 204 to the second region 208 to generate the one or more relocated features 166 in the modified cylindrical representation 164.

The method 400 further includes, based on the modified cylindrical representation, performing one or more three-dimensional (3D) perception operations associated with the scene, at 408. For example, the one or more 3D perception operations may include the one or more 3D perception operations 190 of FIG. 1. In some implementations, the one or more 3D perception operations may include the illustrative examples of the one or more 3D perception operations 190 depicted in FIG. 3.

In some aspects, a device (e.g., the device 100) includes a processing system that includes one or more processors (e.g., the processor 104) and one or more memories (e.g., the memory 106) coupled to the one or more processors. The processing system is configured to perform one or more operations described herein, such as operations of the method 400 of FIG. 4. In some other aspects, a non-transitory computer-readable medium (e.g., the memory 106) stores instructions (e.g., the instructions 108) executable by one or more processors (e.g., the processor 104) to initiate, perform, or control one or more operations described herein, such as operations of the method 400 of FIG. 4.

One or more features described herein may improve performance of a device (such as a vehicle) that performs three-dimensional (3D) perception operations. For example, by relocating a feature associated with an object that appears in multiple fields of view of different sensors (such as the feature F, which may appear in fields of view of both the first LiDAR sensor 182 and the second LiDAR sensor 184), such a feature may appear continuous (or linear) instead of discontinuous (or curved). As a result, the device 100 may achieve certain benefits of cylindrical representations (such as by reducing or avoiding the problem of long-tailed distribution of density) while reducing or avoiding inaccurate representation of some detected objects (such as by reducing or avoiding undesirable curvature or discontinuity of an elongated object, such as a guard rail, barrier, or trailer).

To further illustrate some aspects of the disclosure, in a first aspect, an apparatus includes a processing system that includes one or more processors and one or more memories coupled to the one or more processors. The processing system is configured to receive sensor data associated with a scene and to generate a cylindrical representation associated with the scene. The processing system is further configured to modify the cylindrical representation based on detecting a feature of the cylindrical representation being included in a first region of the cylindrical representation. Modifying the cylindrical representation includes relocating the feature from the first region to a second region that is different than the first region. The processing system is further configured to perform, based on the modified cylindrical representation, one or more three-dimensional (3D) perception operations associated with the scene.

In a second aspect, in combination with the first aspect, the feature is associated with a radial distance from an origin of the cylindrical representation, and the processing system is further configured to modify the radial distance based on a radial adjustment value to generate the modified cylindrical representation.

In a third aspect, in combination with one or more of the first aspect or the second aspect, the radial adjustment value is negative one.

In a fourth aspect, in combination with one or more of the first aspect through the third aspect, the feature is associated with an angular distance from a polar axis of the cylindrical representation, and the processing system is further configured to modify the angular distance based on an angular shift value to generate the modified cylindrical representation.

In a fifth aspect, in combination with one or more of the first aspect through the fourth aspect, the angular shift value is pi radians.

In a sixth aspect, in combination with one or more of the first aspect through the fifth aspect, a boundary between the first region and the second region corresponds to a particular value of an angular coordinate associated with the cylindrical representation.

In a seventh aspect, in combination with one or more of the first aspect through the sixth aspect, the particular value is zero.

In an eighth aspect, in combination with one or more of the first aspect through the seventh aspect, the first region is associated with values of the angular coordinate of greater than or equal to zero, and the second region is associated with values of the angular coordinate of less than zero.

In a ninth aspect, in combination with one or more of the first aspect through the eighth aspect, the processing system is further configured to reflect the feature across the boundary to generate the modified cylindrical representation.

In a tenth aspect, in combination with one or more of the first aspect through the ninth aspect, the one or more 3D perception operations include one or more of object detection, instance segmentation, lane detection, or road detection.

In an eleventh aspect, in combination with one or more of the first aspect through the tenth aspect, the apparatus further includes a first sensor configured to generate first sensor data and a second sensor configured to generate second sensor data. The sensor data includes the first sensor data and the second sensor data.

In a twelfth aspect, in combination with one or more of the first aspect through the eleventh aspect, the scene includes an object represented by both the first sensor data and the second sensor data, and one or more of continuity or linearity associated with the object is increased in the modified cylindrical representation as compared to the cylindrical representation.

In a thirteenth aspect, in combination with one or more of the first aspect through the twelfth aspect, the apparatus corresponds to a vehicle, the first sensor corresponds to a front-facing sensor of the vehicle, and the second sensor corresponds to a rear-facing sensor of the vehicle or a side-facing sensor of the vehicle.

In a fourteenth aspect, a method includes receiving sensor data associated with a scene and generating a cylindrical representation associated with the scene. The method further includes modifying the cylindrical representation based on detecting a feature of the cylindrical representation being included in a first region of the cylindrical representation. Modifying the cylindrical representation includes relocating the feature from the first region to a second region that is different than the first region. The method further includes performing one or more three-dimensional (3D) perception operations associated with the scene based on the modified cylindrical representation.

In a fifteenth aspect, in combination with the fourteenth aspect, the feature is associated with a radial distance from an origin of the cylindrical representation, and relocating the feature from the first region to the second region includes modifying the radial distance based on a radial adjustment value.

In a sixteenth aspect, in combination with one or more of the fourteenth aspect through the fifteenth aspect, the radial adjustment value is negative one.

In a seventeenth aspect, in combination with one or more of the fourteenth aspect through the sixteenth aspect, the feature is associated with an angular distance from a polar axis of the cylindrical representation, and relocating the feature from the first region to the second region includes modifying the angular distance based on an angular shift value.

In an eighteenth aspect, in combination with one or more of the fourteenth aspect through the seventeenth aspect, the angular shift value is pi radians.

In a nineteenth aspect, in combination with one or more of the fourteenth aspect through the eighteenth aspect, a boundary between the first region and the second region corresponds to a particular value of an angular coordinate associated with the cylindrical representation.

In a twentieth aspect, in combination with one or more of the fourteenth aspect through the nineteenth aspect, the particular value is zero.

In a twenty-first aspect, in combination with one or more of the fourteenth aspect through the twentieth aspect, the first region is associated with values of the angular coordinate of greater than or equal to zero, and the second region is associated with values of the angular coordinate of less than zero.

In a twenty-second aspect, in combination with one or more of the fourteenth aspect through the twenty-first aspect, relocating the feature includes reflecting the feature across the boundary.

In a twenty-third aspect, in combination with one or more of the fourteenth aspect through the twenty-second aspect, the one or more 3D perception operations include one or more of object detection, instance segmentation, lane detection, or road detection.

In a twenty-fourth aspect, in combination with one or more of the fourteenth aspect through the twenty-third aspect, the sensor data includes first sensor data associated with a first sensor and further includes second sensor data associated with a second sensor, the scene includes an object represented by both the first sensor data and the second sensor data, and relocating the feature increases one or more of continuity or linearity associated with the object in the modified cylindrical representation as compared to the cylindrical representation.

In a twenty-fifth aspect, in combination with one or more of the fourteenth aspect through the twenty-fourth aspect, the first sensor corresponds to a front-facing sensor of a vehicle, and the second sensor corresponds to a rear-facing sensor of the vehicle or a side-facing sensor of the vehicle.

In a twenty-sixth aspect, a non-transitory computer-readable medium storing instructions executable by one or more processors to initiate, perform, or control operations. The operations include receiving sensor data associated with a scene and generating a cylindrical representation associated with the scene. The operations further include modifying the cylindrical representation based on detecting a feature of the cylindrical representation being included in a first region of the cylindrical representation. Modifying the cylindrical representation includes relocating the feature from the first region to a second region that is different than the first region. The operations further include performing one or more three-dimensional (3D) perception operations associated with the scene based on the modified cylindrical representation.

In a twenty-seventh aspect, in combination with the twenty-sixth aspect, the feature is associated with a radial distance from an origin of the cylindrical representation, the feature is associated with an angular distance from a polar axis of the cylindrical representation, and relocating the feature from the first region to the second region includes modifying the radial distance based on a radial adjustment value and modifying the angular distance based on an angular shift value.

In a twenty-eighth aspect, in combination with one or more of the twenty-sixth aspect through the twenty-seventh aspect, the angular shift value is pi radians, and the radial adjustment value is negative one.

In a twenty-ninth aspect, in combination with one or more of the twenty-sixth aspect through the twenty-eighth aspect, the sensor data includes first sensor data associated with a first sensor and further includes second sensor data associated with a second sensor, the scene includes an object represented by both the first sensor data and the second sensor data, and relocating the feature increases one or more of continuity or linearity associated with the object in the modified cylindrical representation as compared to the cylindrical representation.

In a thirtieth aspect, in combination with one or more of the twenty-sixth aspect through the twenty-ninth aspect, the first sensor corresponds to a front-facing sensor of a vehicle, and the second sensor corresponds to a rear-facing sensor of the vehicle or a side-facing sensor of the vehicle.

In the figures, a single block may be described as performing a function or functions. The function or functions performed by that block may be performed in a single component or across multiple components, and/or may be performed using hardware, software, or a combination of hardware and software. Whether such functionality is implemented as hardware or software may depend upon the particular application and design of the overall system. Skilled artisans may implement the described functionality in varying ways for each particular application, but such implementation decisions should not be interpreted as causing a departure from the scope of the present disclosure.

Aspects of the present disclosure may be applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

A hardware and data processing apparatus used to implement one or more illustrative logics, logical blocks, modules and circuits described in connection with the aspects disclosed herein may be implemented or performed with a single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
a processing system that includes one or more processors and one or more memories coupled to the one or more processors, the processing system configured to:
receive sensor data associated with a scene;
generate a cylindrical representation associated with the scene;
based on detecting a feature of the cylindrical representation being included in a first region of the cylindrical representation, modify the cylindrical representation, wherein modifying the cylindrical representation includes relocating the feature from the first region to a second region that is different than the first region; and
based on the modified cylindrical representation, perform one or more three-dimensional (3D) perception operations associated with the scene.

2. The apparatus of claim 1, wherein the feature is associated with a radial distance from an origin of the cylindrical representation, and wherein the processing system is further configured to modify the radial distance based on a radial adjustment value to generate the modified cylindrical representation.

3. The apparatus of claim 2, wherein the radial adjustment value is negative one.

4. The apparatus of claim 1, wherein the feature is associated with an angular distance from a polar axis of the cylindrical representation, and wherein the processing system is further configured to modify the angular distance based on an angular shift value to generate the modified cylindrical representation.

5. The apparatus of claim 4, wherein the angular shift value is pi radians.

6. The apparatus of claim 1, wherein a boundary between the first region and the second region corresponds to a particular value of an angular coordinate associated with the cylindrical representation.

7. The apparatus of claim 6, wherein the particular value is zero.

8. The apparatus of claim 6, wherein the first region is associated with values of the angular coordinate of greater than or equal to zero, and wherein the second region is associated with values of the angular coordinate of less than zero.

9. The apparatus of claim 6, wherein the processing system is further configured to reflect the feature across the boundary to generate the modified cylindrical representation.

10. The apparatus of claim 1, wherein the one or more 3D perception operations include one or more of object detection, instance segmentation, lane detection, or road detection.

11. The apparatus of claim 1, further comprising:
a first sensor configured to generate first sensor data; and
a second sensor configured to generate second sensor data,
wherein the sensor data includes the first sensor data and the second sensor data.

12. The apparatus of claim 11, wherein the scene includes an object represented by both the first sensor data and the second sensor data, and wherein one or more of continuity or linearity associated with the object is increased in the modified cylindrical representation as compared to the cylindrical representation.

13. The apparatus of claim 11, wherein the apparatus corresponds to a vehicle, wherein the first sensor corresponds to a front-facing sensor of the vehicle, and wherein the second sensor corresponds to a rear-facing sensor of the vehicle or a side-facing sensor of the vehicle.

14. A method comprising:
receiving sensor data associated with a scene;
generating a cylindrical representation associated with the scene;
based on detecting a feature of the cylindrical representation being included in a first region of the cylindrical representation, modifying the cylindrical representation, wherein modifying the cylindrical representation includes relocating the feature from the first region to a second region that is different than the first region; and
based on the modified cylindrical representation, performing one or more three-dimensional (3D) perception operations associated with the scene.

15. The method of claim 14, wherein the feature is associated with a radial distance from an origin of the cylindrical representation, and wherein relocating the feature from the first region to the second region includes modifying the radial distance based on a radial adjustment value.

16. The method of claim 15, wherein the radial adjustment value is negative one.

17. The method of claim 14, wherein the feature is associated with an angular distance from a polar axis of the cylindrical representation, and wherein relocating the feature from the first region to the second region includes modifying the angular distance based on an angular shift value.

18. The method of claim 17, wherein the angular shift value is pi radians.

19. The method of claim 14, wherein a boundary between the first region and the second region corresponds to a particular value of an angular coordinate associated with the cylindrical representation.

20. The method of claim 19, wherein the particular value is zero.

21. The method of claim 19, wherein the first region is associated with values of the angular coordinate of greater than or equal to zero, and wherein the second region is associated with values of the angular coordinate of less than zero.

22. The method of claim 19, wherein relocating the feature includes reflecting the feature across the boundary.

23. The method of claim 14, wherein the one or more 3D perception operations include one or more of object detection, instance segmentation, lane detection, or road detection.

24. The method of claim 14, wherein the sensor data includes first sensor data associated with a first sensor and further includes second sensor data associated with a second sensor, wherein the scene includes an object represented by both the first sensor data and the second sensor data, and wherein relocating the feature increases one or more of continuity or linearity associated with the object in the modified cylindrical representation as compared to the cylindrical representation.

25. The method of claim 24, wherein the first sensor corresponds to a front-facing sensor of a vehicle, and wherein the second sensor corresponds to a rear-facing sensor of the vehicle or a side-facing sensor of the vehicle.

26. A non-transitory computer-readable medium storing instructions executable by one or more processors to initiate, perform, or control operations, the operations comprising:
receiving sensor data associated with a scene;
generating a cylindrical representation associated with the scene;
based on detecting a feature of the cylindrical representation being included in a first region of the cylindrical representation, modifying the cylindrical representation, wherein modifying the cylindrical representation includes relocating the feature from the first region to a second region that is different than the first region; and
based on the modified cylindrical representation, performing one or more three-dimensional (3D) perception operations associated with the scene.

27. The non-transitory computer-readable medium of claim 26, wherein the feature is associated with a radial distance from an origin of the cylindrical representation, wherein the feature is associated with an angular distance from a polar axis of the cylindrical representation, and wherein relocating the feature from the first region to the second region includes:
modifying the radial distance based on a radial adjustment value; and
modifying the angular distance based on an angular shift value.

28. The non-transitory computer-readable medium of claim 27, wherein the angular shift value is pi radians, and wherein the radial adjustment value is negative one.

29. The non-transitory computer-readable medium of claim 26, wherein the sensor data includes first sensor data associated with a first sensor and further includes second sensor data associated with a second sensor, wherein the scene includes an object represented by both the first sensor data and the second sensor data, and wherein relocating the feature increases one or more of continuity or linearity associated with the object in the modified cylindrical representation as compared to the cylindrical representation.

30. The non-transitory computer-readable medium of claim 29, wherein the first sensor corresponds to a front-facing sensor of a vehicle, and wherein the second sensor corresponds to a rear-facing sensor of the vehicle or a side-facing sensor of the vehicle.
